(19) United States
(12) Patent Application Publication
(10) Pub. No.: US 2019/0203972 A1
(43) Pub. Date: Jul. 4, 2019

(54) CONNECTING DUCTS

(71) Applicant: Doby Cleats Limited, Durham (GB)

(72) Inventor: Malcolm Moss, Durham (GB)

(21) Appl. No.: 16/282,150

(22) Filed: Feb. 21, 2019

Related U.S. Application Data
(63) Continuation of application No. PCT/GB2017/052484, filed on Aug. 23, 2017.

(30) Foreign Application Priority Data
Aug. 23, 2016 (GB) 1614395.0

(51) Int. Cl. F24F 13/02; F16L 23/14

(52) U.S. Cl. CPC F24F 13/0209; F16L 23/14

(57) ABSTRACT

A duct apparatus comprises a first duct section (9) and a second duct section (9′), each duct section being provided with a connector assembly (1,1′) for use in connecting the first duct section to the second duct section. Each connector assembly comprises a plurality of flange elements (2), and a plurality of corner elements (3). Each flange element includes attachment means for attachment of an end face of the duct section thereto, and each corner element engages with two flange elements. The first duct section is attached to the second duct section using a two-sided adhesive tape (13) applied around the perimeter of the connector assembly of the first duct section. The two-sided tape both adheres the first section to the second duct suction and provides a seal between the two duct sections. A method of connecting a first duct section to a second duct section using the duct apparatus is also provided.

### FIELD OF THE INVENTION

The present invention relates to connecting ducts and in particular to an apparatus and method for connecting ducts.

### BACKGROUND OF THE INVENTION

Ducting is commonly used in large buildings such as factories, office blocks and apartment blocks for the transmission of air, which may be for the purposes of heating or cooling an environment in a building, or ventilating a building. Typically, such ducts are used to transport heated or cooled air and the ducts may be insulated as described in GB2423343. GB2423343 describes a method for connecting insulated ducts in which four flange pieces are connected to four corner pieces to form a rectangular flange frame. The rectangular flange frame is then fitted to the end of each duct section and attached thereto using various methods such as spot welds or rivets. Sealant must then be applied along the edge of the flange on the inside of the duct, and around the corner pieces. When fitting two duct sections together a rubber gasket is placed between the flanges and the flanges are connected together by bolts at the corners and clips or cleats or clamps along the flange edges to ensure a sturdy joint. Both the application of sealant to the flange frame, and the use of clip, cleat or clamp fasteners is time consuming. In addition, the flange frames, joined together by clips, cleats or clamps are prone to bowing or warping under pressure which can compromise the duct seal.

US2009/0309358 describes method for joining segmented ducts, where the duct sections are formed from a single piece of sheet metal folded to form a duct section with a generally rectangular cross-section. Adhesive is applied to the flanges and used to join segments together. The adhesive provides an air seal and avoids the need to wrap tape around the joint. Mechanical fasteners such as clips may also be needed.
It would be desirable to provide an improved method for the connection of duct sections.

### SUMMARY OF THE INVENTION

According to a first aspect of the invention there is provided a duct apparatus comprising a first duct section and a second duct section, each duct section being provided with a connector assembly for use in connecting the first duct section to the second duct section, the connector assembly comprising a plurality of flange elements, and a plurality of corner elements, wherein each flange element includes attachment means for attachment of an end face of the duct section thereto, and each corner element engages with two flange elements wherein the first duct section is attached to the second duct section using a two-sided adhesive tape applied around the perimeter of the connector assembly of the first duct section, and wherein the two-sided tape both adheres the first section to the second duct section and provides a seal between the two duct sections.

Preferably, the attachment means comprises an opening in the flange element into which the duct section is inserted.

Preferably, the flange element includes a corner element receiving means. Preferably, the receiving means comprises an opening so shaped and dimensioned as to receive a part of a corner element. Preferably, the said part of a corner element is a push fit in the opening.

Preferably, the two-sided adhesive tape is provided in a continuous length. When provided in a continuous length, the tape has a first end and a second end and preferably the two ends overlap by a distance of at least 5 mm. Preferably the two ends overlap by a distance in the range 5-50 mm.

Alternatively, the two-sided adhesive tape is provided in a number of discrete lengths. Each length of tape has a first end and a second end and each first end of each length of tape overlaps with a second end of a different length of tape by a distance of at least 5 mm.

An additional length of adhesive tape may be provided at each corner element of the connector assembly of the first duct section.

According to a second aspect of the invention there is provided a method of connecting a first duct section to a second duct section comprising the steps of:
i) attaching a connector assembly to the first duct section and attaching a connector assembly to the second duct section, the connector assembly comprising a plurality of flange elements, and a plurality of corner elements, wherein each flange element includes attachment means for attachment of an end face of the duct section thereto, and wherein, each corner element engages with two flange elements, and wherein each corner element includes an aperture for receipt of a fastener;
ii) applying two-sided adhesive tape to the connector assembly of the first duct section;
iii) aligning the connector assemblies of the first and second ducts and inserting a fastener through the aperture of each corner element;
iv) securing the said duct sections together with fastener; and
v) applying pressure to the connector assemblies to secure the duct sections together with the adhesive tape.

Preferably, the two-sided adhesive tape is provided in a continuous length. When provided in a continuous length, the tape has a first end and a second end and preferably the two ends overlap by a distance of at least 5 mm. Preferably the two ends overlap by a distance in the range 5-50 mm.

Preferably, the method includes the further step of applying additional lengths of two-sided adhesive tape to the corner elements of the connector assembly of the first duct section prior to step iii).

The apparatus of the invention allows for an improved method for connection together of duct sections and be used with both insulated and uninsulated duct sections. The use of a two-sided adhesive tape to adhere the connector assemblies together on all sides allows for a stiffer structure which is less prone to bowing or warping under pressure and hence provides an improved seal.

### BRIEF DESCRIPTION OF THE DRAWINGS

In the drawings, which illustrate a preferred embodiment of the apparatus of the invention, and are by way of example:

FIG. 1a is a plan view of a connector assembly according to an aspect of the invention;

FIG. 1b is a perspective view of the connector assembly of FIG. 1a, in a partially assembled state;

FIG. 2a is an end view of a flange section forming part of the connector assembly of FIG. 1a;

FIG. 2b is an end view of a flange section forming part of the connector assembly of FIG. 1a attached to a duct wall;

FIG. 3 is a schematic representation of a corner element forming part of the connector assembly of FIG. 1a;

FIG. 4 is a schematic representation of two flange sections as illustrated in FIG. 2a attached to a corner element as illustrated in FIG. 3;

FIG. 5 is a plan view of the connector assembly of FIG. 1a with adhesive tape applied;

FIG. 6 is a perspective view of a first duct with the connector assembly of FIG. 1a attached and adhesive tape applied;

FIG. 7 is a perspective view of a corner of a first duct with the connector assembly of FIG. 1a attached and adhesive tape applied;

FIG. 8 is a side view of two ducts each equipped with connector assemblies of FIG. 1a immediately prior to joining; and

FIG. 9 is a detailed cross-section through the flange sections of one of the sides of the ducts of FIG. 7 after joining.

### DETAILED DESCRIPTION OF THE PREFERRED EMBODIMENTS

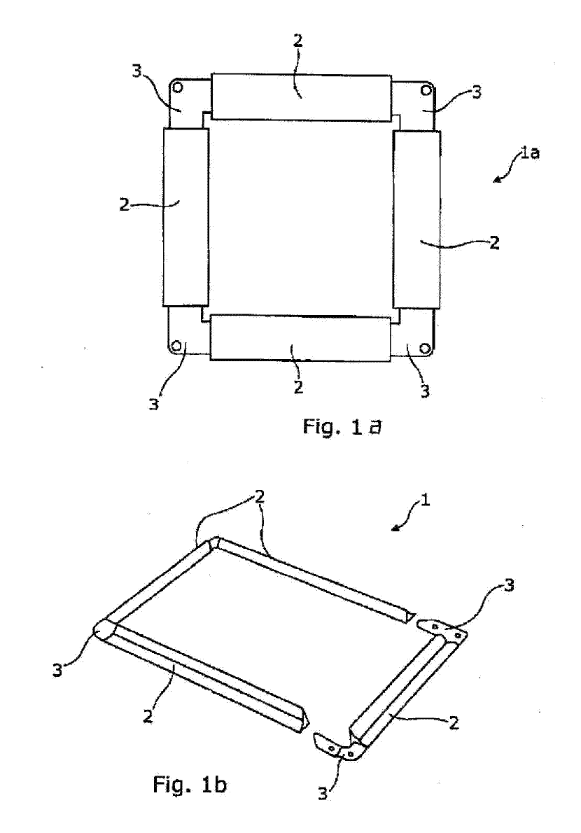

As shown in FIGS. 1a and 1b, a connector assembly, shown generally at 1, comprises four flange sections 2 joined together by four corner elements 3. The corner elements 3 are preferably right angled to provide for the attachment of rectangular or square duct sections.

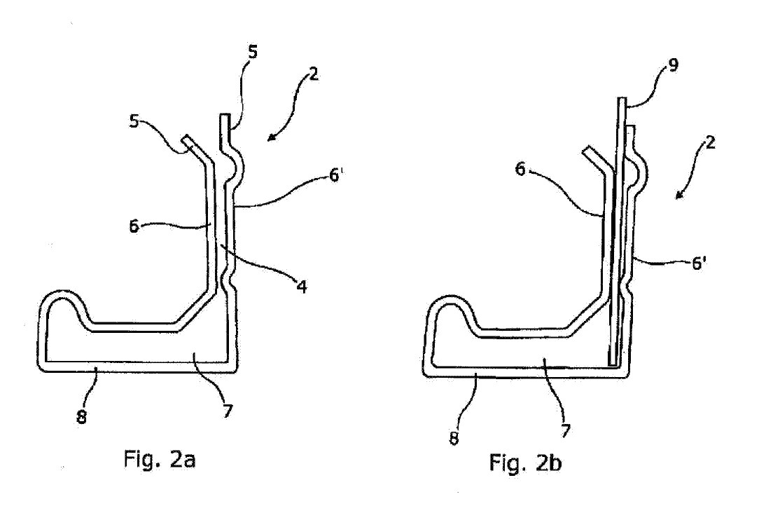

FIGS. 2a and 2b show the profile of one of the flange sections 2. The profile provides a channel 4 having walls 6, 6′ each of which terminate with a lip 5 projecting outwardly of the channel 4. The channel 4 is shaped for receipt of a duct wall 9 (see FIG. 2b). The channel 4 may be narrow for receipt of a thin duct wall 9 as shown in FIG. 2b, or alternatively, the channel 4 may be wider, as shown in FIG. 4, for receipt of a thicker duct wall such as an insulated duct wall (not shown). The flange section 2 has a substantially flat base 8 which includes a channel 7 therein. As shown in FIG. 2b, the wall width of the duct 7, 7′ is fractionally greater than the distance between the walls 6, 6′ of the flange section 2. The lips 5 provide an opening to the channel 4 that is wider than the wall width of the duct 6, 6′, enabling the duct wall 6, 6′ to be inserted easily into the channel 4 of the flange section 2.

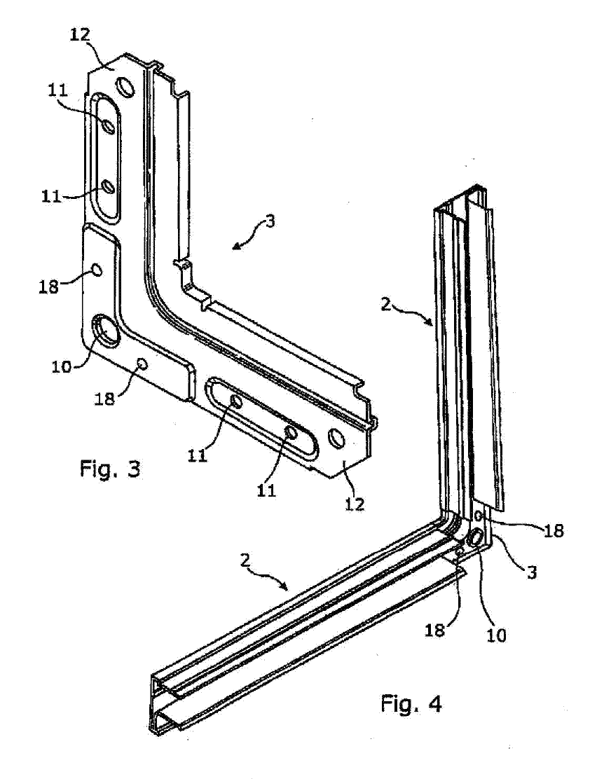

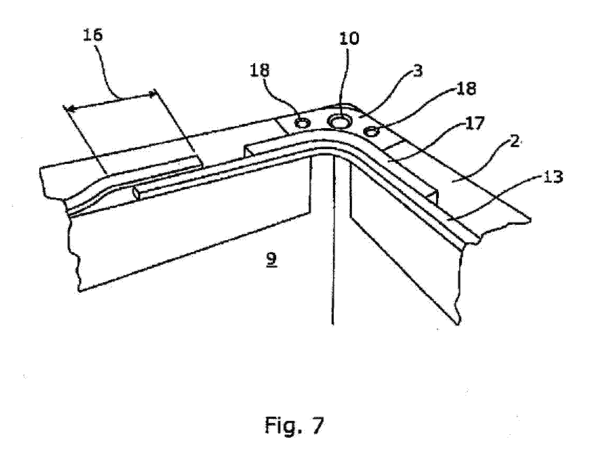

FIG. 3 illustrates a corner element 3, taking the form of a right angled plate. The corner element 3 includes an aperture 10 which is used in the connection of one duct to another (see FIG. 7). The corner element 3 also includes two leg portions 12 which are shaped to be received within a base channel 7 of a flange section 2 as a push fit.

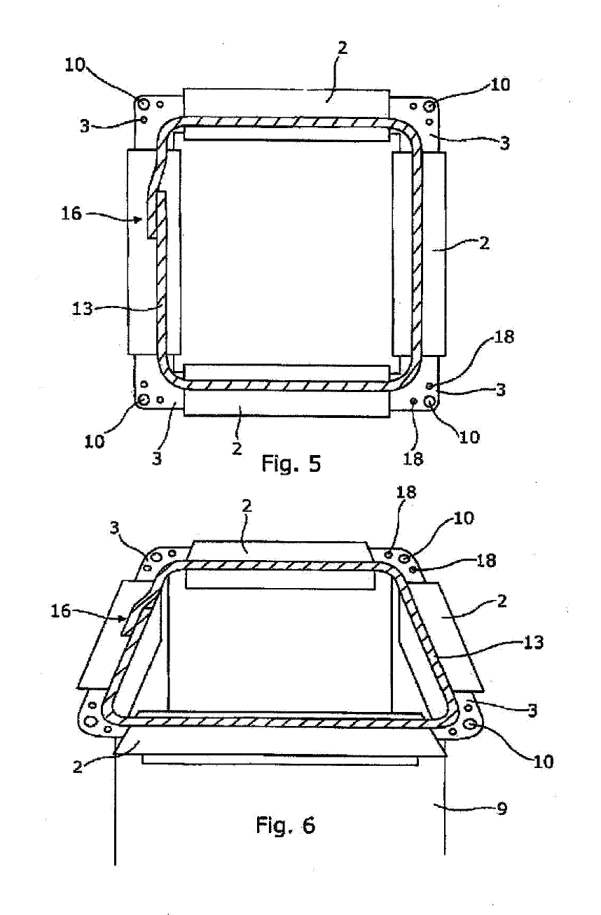

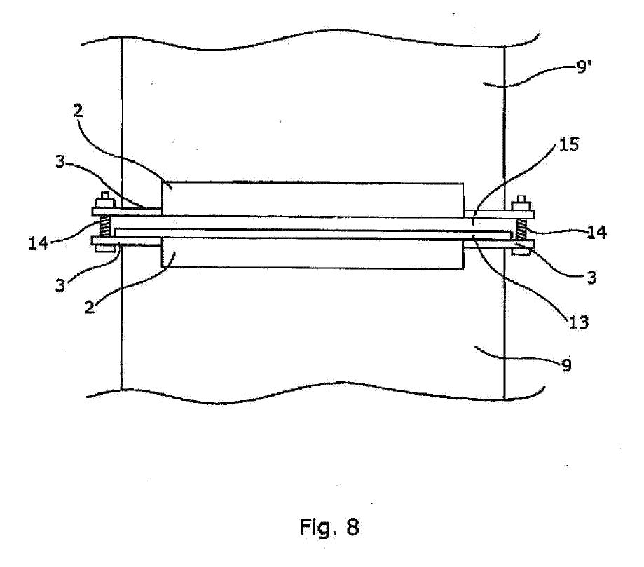

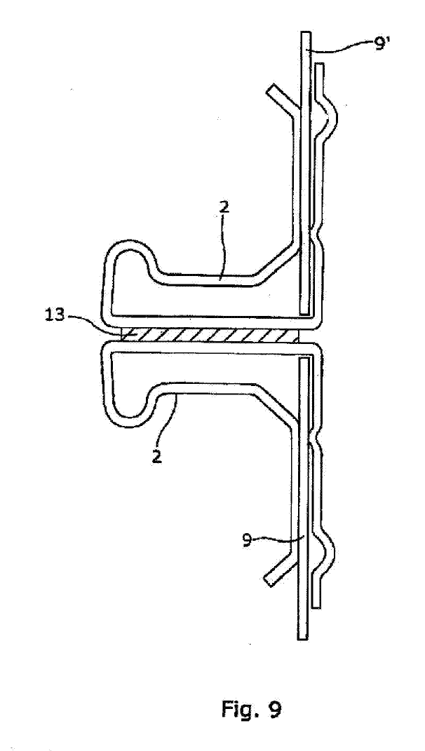

To assemble the connector assembly 1, lengths of flange sections 2 are cut to suit the ducts being connected. The leg portions 12 of four corner sections 3 are then pushed into the ends of the channels 7 located in the base 8 of the four flange sections 2 to form a substantially rectangular or square connector assembly 1. During assembly the flange sections 2 may be punched to form dimples which engage with with apertures 11 on the corner element 3. Engagement of these dimples with apertures 11 assist in keeping the duct connector assembly 1 rigid. FIG. 4 illustrates one corner element 3 connected to two flange sections 2. The four flange sections 2 of the connector assembly 1 are then pressed onto the duct section 9 such that the end of the duct walls are received within the channel 4 in each flange section. This procedure is repeated to attach a second connector assembly 1′ to a second duct section 9′. A sealant may be applied between the connector assembly 1, 1′ and the duct 9, 9′. As shown in FIGS. 5 and 6, a two-sided adhesive tape 13 is then applied to the perimeter of the connector assembly 1 attached to the first duct section 9. The tape 13 is applied to the face of the connector assembly 1 which is to be mated with the second connector assembly 1, located on a second duct section 9′. The tape 13 is applied all the way around the perimeter of the connector assembly 1 on the first duct section 9 without leaving any gaps, preferably as one continuous length of tape. In order to complete the seal the ends of the tape should overlap as shown at 16. Preferably the minimum overlap is 5 mm, but ideally approximately 30 mm. Additional lengths of tape 17, or other suitable gasket may be added at the corners as shown in FIG. 7 to improve the seal. At this stage a protective film 15 remains applied to the outer surface of the tape. As shown in FIG. 8, a small length of the protective film from the tape is then peeled back and folded at right angles to the flange section 2.

With reference to FIG. 8, a second duct section 9′ (which has no adhesive tape applied to the connector assembly 1′) is then aligned to the first duct section 1, and four corner bolts 14 are loosely fitted in the apertures 10 of each corner element 3, leaving a gap between the two faces of the mating connector assemblies 1, 1′. Joggle holes 18 can be used to align the ducts sections 9, 9′ correctly by inserting a rod or similar tool through the partially aligned joggle holes 18 and manipulating the rod to align the duct sections. The protective film 15 from the tape 13 is then peeled away to expose the second adhesive surface of the tape 13 by pulling gently on the tab of protective film 15 previously folded back. Once all of the protective film 15 is removed from the adhesive tape 13, 17 the four corner bolts 14 are tightened and pressure is applied along each side of the connector assemblies 1, 1′ to firmly adhere the two surfaces together. FIG. 9 illustrates a detailed cross-section through the two flange sections 2 adhered together using the two-sided adhesive tape 13. No further clips, cleats or clamps are required to secure the duct sections 9, 9′ together, speeding up the process for joining duct sections considerably.

The two-sided adhesive tape begins to bond on impact but is re-positionable for a number of minutes after application to assist in the connection of the ducts at the correct orientation.

As the ducts are adhered together along the length of each flange section 2 the structure of the connector assembly 1 is stiffened and there is less tendency for the connector assembly 1 to bow out or bend during use, compromising the duct seal.

1. A duct apparatus comprising a first duct section and a second duct section, each duct section being provided with a connector assembly for use in connecting the first duct section to the second duct section, each connector assembly comprising a plurality of flange elements, and a plurality of corner elements, wherein each flange element includes attachment means for attachment of an end face of a duct section thereto, and each corner element engages with two flange elements, wherein the first duct section is attached to the second duct section using a two-sided adhesive tape applied around the perimeter of the connector assembly of the first duct section, and wherein the two-sided tape both adheres the first section to the second duct section and provides a seal between the two duct sections.

2. A duct apparatus according to claim 1, the attachment means comprising an opening in the flange element into which the duct section is inserted.

3. A duct apparatus according to claim 1, wherein the flange element includes a corner element receiving means.

4. A duct apparatus according to claim 1, wherein the receiving means comprises an opening so shaped and dimensioned as to receive a part of a corner element.

5. A duct apparatus according to claim 4, wherein the said part of a corner element is a push fit in the opening.

6. A duct apparatus according to claim 1, wherein the two-sided adhesive tape is provided in a continuous length.

7. A duct apparatus according to claim 6, wherein the tape has a first end and a second end and the two ends overlap by a distance of at least 5 mm.

8. A duct apparatus according to claim 1, wherein the two-sided adhesive tape is provided in a number of discrete lengths.

9. A duct apparatus according to claim 8, wherein each length of tape has a first end and a second end and each first end of each length of tape overlaps with a second end of a different length of tape by a distance of at least 5 mm.

10. A duct apparatus according to claim 1, further comprising an additional length of tape at each corner element of the connector assembly of the first duct section.

11. A method of connecting a first duct section to a second duct section comprising the steps of:
a. attaching a connector assembly to the first duct section and attaching a connector assembly to the second duct section, each connector assembly comprising a plurality of flange elements, and a plurality of corner elements, wherein each flange element includes attachment means for attachment of an end face of the duct section thereto, and wherein, each corner element engages with two flange elements, and wherein each corner element includes an aperture for receipt of a fastener;
b. applying two-sided adhesive tape to the connector assembly of the first duct section;
c. aligning the connector assemblies of the first and second ducts and inserting a fastener through the aperture of each corner element;
d. securing the said duct sections together with fastener; and
e. applying pressure to the connector assemblies to secure the duct sections together with the adhesive tape.

12. A method according to claim 11, wherein the tape is applied in a continuous length.

13. A method according to claim 12 wherein the tape has two ends which overlap by a distance of at least 5 mm.

14. A method according to claim 11, further comprising the step of applying additional lengths of two-sided adhesive tape to the corner elements of the connector assembly of the first duct section prior to step iii).

15. (canceled)
